(19) United States
(12) Patent Application Publication
(10) Pub. No.: US 2022/0050763 A1
(43) Pub. Date: Feb. 17, 2022

(54) DETECTING REGIME CHANGE IN TIME SERIES DATA TO MANAGE A TECHNOLOGY PLATFORM

(71) Applicant: Smart Software, Inc., Belmont, MA (US)

(72) Inventors: Thomas Reed Willemain, Niskayuna, NY (US); Nelson Seth Hartunian, Belmont, MA (US)

(21) Appl. No.: 17/399,287

(22) Filed: Aug. 11, 2021

Related U.S. Application Data
(60) Provisional application No. 63/064,112, filed on Aug. 11, 2020.

(51) Int. Cl. G06F 11/34; G06F 17/18

(52) U.S. Cl. CPC G06F 11/3452; G06F 17/18

(57) ABSTRACT

A system and method are provided for detecting a significant change in the character of a time series collected from a technology platform. A system is disclosed that includes a memory; and a processor coupled to the memory and configured to process time series data for a set of resources according to a method that includes: collecting time series data associated with resources in a technology platform; analyzing each of a plurality of time series to determine whether a regime change occurred, and in response to a detected regime change in a time series, truncating the time series to generate a revised time series; and utilizing the revised time series to facilitate management or control the technology platform.

### BACKGROUND OF THE INVENTION

### Technical Field

The present invention relates generally to systems that collect and process time series data, and more particularly to detecting a regime change in time series data to manage technology platforms more effectively.

### Background

There exist numerous technology platforms in which time series data associated with any number of platform resources is captured and analyzed. The resulting analysis is then fed back to improve the operation of the platform. Illustrative platforms and their associated resources may for example include: cloud computing systems having resources such as distributed processors, memory and hardware resources; web resources on the Internet; communication networks having resources such as switches, cell towers, routers; virtual computing platforms having software resources; autonomous systems such as self-driving vehicles, robots and drones; Internet of Things (IoT) platforms; automated control systems; energy management systems having resources such as solar cells and windmills; inventory control systems; enterprise resource planning (ERP) systems, etc.

The resulting analysis of time series data may for example be used to identify trends and forecast future values. Future values may for example be used to route communication traffic, load balance cloud resources, control a machine, re-order inventory, etc.

### SUMMARY OF THE INVENTION

A system, method and program product are provided for processing time series data associated with a technology platform to identify a major shift in the character of the time series. Such a shift is referred to herein as a “regime change.” In one aspect, a system includes a regime change detector that accepts as input sequential observations (i.e., a time series) associated with resources of a technology platform. As output, the detector provides either (a) a shorter time series consisting only of observations from the current regime or (b) the original time series, having established that there is insufficient evidence that any regime change occurred. Once provided, the resulting time series data can be utilized by a post processing system to facilitate management of the technology platform.

In one aspect, a system is provided that includes a memory and a processor coupled to the memory and configured to process time series data for a set of resources according to a method that includes: collecting time series data associated with resources in a technology platform; analyzing each of a plurality of time series to determine whether a regime change occurred, and in response to a detected regime change in a time series, truncating the time series to generate a revised time series; and utilizing the revised time series to facilitate management of the technology platform.

In a second aspect, a method of processing time series data for a set of resources in a technology platform is provided and includes: collecting time series data associated with resources in the technology platform; analyzing each of a plurality of time series to determine whether a regime change occurred by evaluating distributions of values within the time series, and in response to a detected regime change in a time series, truncating the time series to generate a revised time series; and utilizing the revised time series to predict future behavior of the resource in the technology platform.

In a third aspect, a system is provided that includes a memory and a processor coupled to the memory and configured to process time series data for a set of resources according to a method that includes: collecting time series data associated with resources in a technology platform; analyzing each of a plurality of time series to determine whether a regime change occurred, and in response to a detected regime change in a time series, truncating the time series to generate a revised time series; and inputting the revised time series into one of: a machine learning model or predictive model to control an aspect of the technology platform; wherein determining whether the regime change occurred includes: for each point in the current time series, dividing the current time series into a left and a right portion about the point and calculating a test statistic by comparing a distribution of values in the left and the right portions; and identifying the point having a largest test statistic as a potential regime change.

In certain approaches, determining whether the regime change occurred for a current time series includes, for each point in the current time series, dividing the current time series into a left and a right portion about the point; and calculating a test statistic by comparing a distribution of values in the left and the right portions; and identifying the point having a largest test statistic.

In other approaches, the determining includes comparing the largest test statistic to a threshold, in response to exceeding the threshold, confirming the point having the largest test statistic as the detected regime change, and removing data before the detected regime change in the current time series.

In various embodiments, the determining may also include determining a first test value that comprises an absolute difference between a Student's t-test for mean demand in the left and right portions of the current time series and/or determining a second test value that comprises an absolute difference between a standard deviation in the left and right portions.

In some cases, the determining includes: permuting the current time series to generate a permuted time series; for each point in the permuted time series, evaluating the permuted time series to find a largest first test value and a largest second test value; repeating the permuting and evaluating steps a predetermined number of times (e.g., 25) to generate a dataset of the largest first test values and the largest second test values; identifying the greatest of the largest first test values and largest second test values in the dataset as a first threshold and a second threshold, respectively; for each point in the current time series, evaluating the current time series to find a current largest first test value (first test statistic) and a current largest second test value (second test statistic); in response to the current largest first test value exceeding the first threshold, recognizing a regime change; and/or in response to the current largest first value exceeding the second threshold, recognizing a regime change.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 depicts a time series data processing system that processes time series data for a technology platform in accordance with an embodiment of the invention.

FIG. 2 depicts a flow diagram of a process for detecting a regime change in accordance with an embodiment of the invention.

FIG. 3 depicts a plot of a time series of part demand and a plot of the value of the test statistic for every potential point of regime change in accordance with an embodiment of the invention.

FIG. 4 depicts four examples of time series data showing a regime change in demand data for resources in accordance with an embodiment of the invention.

FIG. 5 depicts a computing system for implementing a data processor in accordance with an embodiment of the invention.

The drawings are intended to depict only typical aspects of the disclosure, and therefore should not be considered as limiting the scope of the disclosure.

### DETAILED DESCRIPTION

Aspects of the present invention provide technical solutions for analyzing time series data of resources in a technology platform to facilitate management of the technology platform. When analyzing time series data, conventional thinking holds that using more data always produces better results. That is true only in idealized circumstances, in which the data generating process is statistically stable. In reality, most processes are subject to any number of random influences that can change the essential character of a time series. For example, when analyzing resource demand data, macroeconomic conditions, competitor actions, self-disruptive innovation, even pandemic virus infections can all cause radical changes in the character, e.g., “look and feel” of a time series. In such circumstances, a “regime change” of the time series may occur in which the older data becomes dangerous, poisoning calculations that should be based only on data from the current regime, i.e., data points following the regime change. Accordingly, for the purposes of this disclosure, regime change refers to a point within a time series at which a significant shift in the character of the time series occurs.

While a trained time series analyst might reliably examine a single time series “by eye” and detect a regime change, in practical situations, a given platform may be tracking many thousands of individual time series associated with different resources of the technology platform (i.e., too many for any analyst to realistically review). Further, the time series data may be processed in real time or near real time that makes manual analysis impracticable. Accordingly, a technical problem arises in the need for an automated solution that can quickly analyze large numbers of series, identify those series that have undergone regime change, and accurately identify the point at which the change happened.

Embodiments disclosed herein provide a technical solution to the aforementioned technical challenges by automatically detecting a regime change in time series data and eliminating the unwanted data before the time series is used to manage or control a technology platform. When a regime change is detected, the earlier data is removed to create a truncated time series and post processing systems can process truncated time series containing only observations relevant to current conditions to more effectively manage the technology platform from which the time series data was obtained or some other platform.

In certain aspects, regime change detection includes identifying a significant change in the character of a time series. Such changes might involve the level (e.g., mean), spread (e.g., variance), correlation structure and/or distributional shape of the observations. Detecting such a change in a statistical regime permits identification and exclusion of obsolete and misleading observations from calculations based on the time series, such as forecasts of future values. Conversely, non-detection of regime change justifies use of the full time series, allowing the greater accuracy and fidelity in calculated outputs that is possible when more stable data are available for use. In certain approaches, the process of detecting regime change requires an additional step of performing multiple comparisons to calculated threshold values when testing the null hypothesis of no regime change.

It is understood that the approaches described herein could be utilized to process and manage any type of time series data associated with resources in a technology platform. Resources could for example include computing resources, energy consumers or producers, web resources, communication resources, physical or virtual components, autonomous vehicles, units of inventory, spare parts, stock keeping units (SKUs), financial resources, etc. In some cases, the described approach could be utilized for analyzing time series data of cloud computing resources, energy grid usage, communication resources, etc. In other cases, the approach could be utilized for enterprise resource planning (ERP) systems that process information to control inventory and manage supply chains, etc.

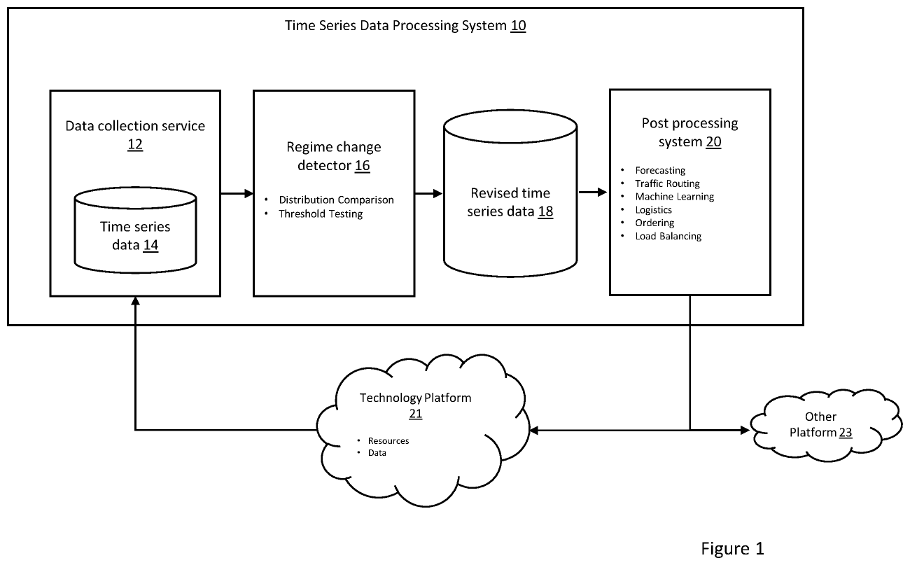

FIG. 1 depicts an illustrative time series data processing system 10 that includes a data collection service 12, which collects multiple sets of times series data 14 that track different aspects of a technology platform 21. As noted, system 10 may be implemented in any domain that captures time series data 14, e.g., cloud computing, a machine learning platform, an automated control system, business forecasting, inventory management, machine control, finance, etc. Thus, for example, time series data 14 may comprise sensor values utilized by a machine learning algorithm to control an autonomous vehicle; monitoring systems that observe cloud computing resources; software agents that control web traffic; ERP information that tracks SKUs in a supply chain, etc. Once collected, time series data 14 is stored and managed by the data processing service 12, such as a database, a control system, an inventory management system, etc.

After being collected, time series data 14 is fed into a regime change detector 16 that analyzes each individual time series and determines if and when a regime change occurred. If a regime change is detected, the time series can be truncated to eliminate data prior to the regime change. The regime change detector 16 accordingly accepts as input sequential observations (a time series) of some aspect such as a quantity of interest for some resource (e.g., memory usage in a cloud platform, daily unit sales of a product, etc.). As output, detector 16 provides revised time series data that is either (a) a shorter time series consisting only of observations from the current regime or (b) the original time series, having established that there is insufficient evidence that any regime change occurred.

After processing by the regime change detector 16, the resulting revised time series data 18 is, e.g., provided to a post processing system 20 that generates some analysis (e.g., displays insights, calculates control parameters, etc.) based on historical behaviors of the data. The analysis of the revised time series data can be fed back to the technology platform 21, or some other platform 23 to facilitate management of the respective platform. For example, in a sensor-based control system, the revised time series data 18 may be fed into a machine learning model within an autonomous vehicle to control operations and/or further train the model, etc. In a communication network, the time series data may be used to control the flow of traffic through switches, routers, etc. In an inventory management system, the revised time series data 18 may be fed into a forecasting system to facilitate re-ordering of inventory. In some implementations, time series data processing system 10 may be implemented as a standalone device that communicates with the technology platform 21 via application programming interfaces (APIs). In other implementations, system 10 can be integrated entirely or partially into platform 21.

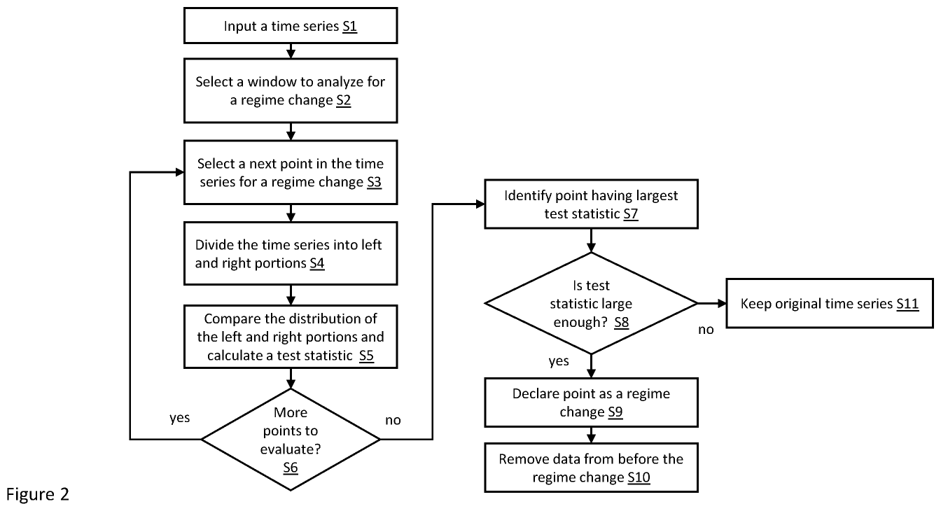

FIG. 2 depicts an illustrative embodiment of a method of detecting regime change. At S1, a current time series is inputted into regime change detector 16 and at S2, some of the data from the time series may be optionally excluded. For example, a portion or window of the time series data can be selected for a regime change analysis. For instance, small intervals at the far left of the time series may be excluded to guarantee enough data to support a statistical test and/or small intervals at the far right may be excluded to ensure a minimum number of observations for use in subsequent analyses of the current regime. At S3-S6, each point in the time series is evaluated as a potential regime change candidate. At S3, a next point is selected (e.g., the process may begin by selecting the earliest point in the time series, and thereafter incrementing forward to a next point). At S4 the time series is divided into left and right portions about the currently selected point. Then at S5, the method compares the distribution of data values in the left and right portions using a statistical test. The test calculates a “test statistic” that measures the degree of difference between the left and right portions of the data. At S5, a determination is made whether there are more points to be evaluated. If yes, then the process returns to S3 to consider the next point. If no, then at S7 the point that produced the largest test statistic is identified as the most likely regime change point. At S8, a determination is made whether the identified test statistic is not only the largest one computed, but also large enough (e.g., greater than a calculated or predetermined threshold) to be statistically unlikely to have occurred by chance. If yes, then at S9 the process declares the corresponding point as the moment in time of a regime change, and at S10 data preceding the regime change point is truncated from further analysis. If no at S8, then the original time series are used in full.

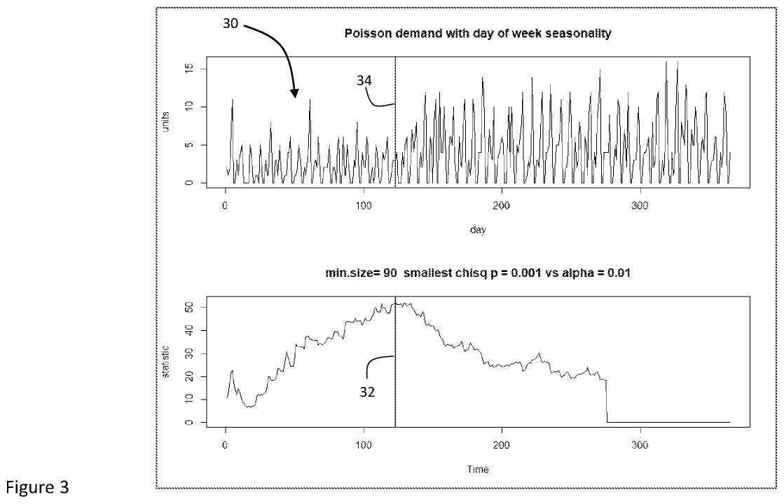

FIG. 3 depicts an illustration of the process in which the top graph depicts a time series of demand in units for each day for a resource from the technology platform 21. As can be seen, the demand 30 for the resource fluctuates over time, making it technically challenging to manually determine if and when a regime change occurred. The bottom graph shows the test statistic (i.e., values on the y axis ranging between 0-50) computed for each point (e.g., each day) in the time series, with the vertical line 32 indicating the point where the largest test statistic value occurred. The vertical line 34 in the top graph indicates where the corresponding regime change occurred in the actual time series 30. Assuming the maximum value of the test statistic was large enough to indicate a regime change (e.g., greater than a threshold), the data prior to vertical line 34 would be excluded from post processing activity.

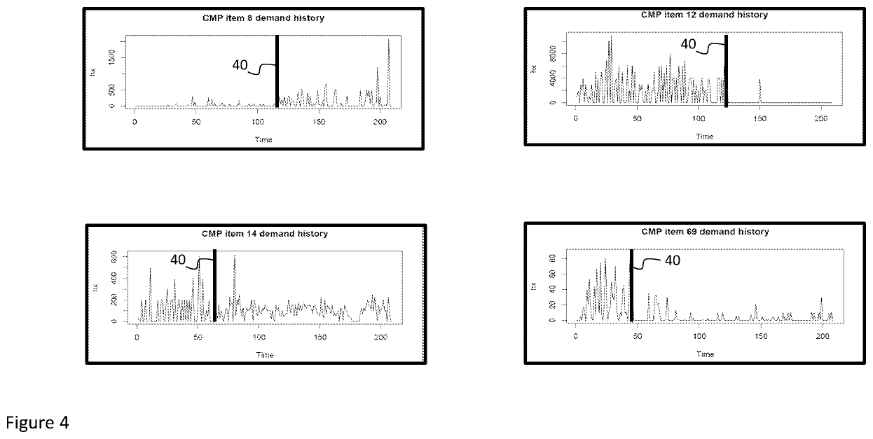

FIG. 4 depicts four additional time series for different technology platform resources, each showing a vertical line 40 indicating a regime change determined by the regime change detector 16 (FIG. 1). In certain implementations, time series data processing system 10 could process a set of times series such as those shown in FIG. 4 in parallel, e.g., using parallel processing, to simultaneously identify regimes changes in the set. In other cases, sets of times series could be processed sequentially.

Any statistical test (or tests) may be utilized to determine the test statistic at each point in a time series. In one illustrative embodiment, the test includes a permutation test that considers two statistics. One statistic is the absolute value of Student's t-test for the difference (i.e., absolute difference) in the mean demand in the left and right portions of the time series. The other statistic is the absolute difference in the two standard deviations. Alternative implementations may for example utilize other two-sample tests, such as the chi-square test, the Kolmogorov-Smirnov test, and the Friedman-Rafsky test applied to a vector of series attributes.

In general, assessing the significance level (i.e., is the test result large enough to warrant a regime change) of any of these tests can involve various challenges that are addressed herein by a threshold test procedure in the regime change detector 16. As noted, regime change candidates in a time series are determined by analyzing some distribution about each point in the series. The process of scanning through such a sequence of observations to evaluate all possible change points can be considered a multiple comparison test. This analysis is however further complicated by the fact that the test results are correlated: testing adjacent potential change points involves highly overlapping data, with only one observation moving from one side of the change point to the other. This can constitute a difficult, non-standard technical problem.

One illustrative solution to the problem utilizes the following steps (in this case for a time series containing a demand history):
1. Read in the demand history.
2. Randomly permute the entire demand history.
3. Scan across all possible change points in the permuted data to find and record the largest absolute difference in Student's t-test for means and the largest absolute difference in standard deviations that were encountered in the scan.
4. Repeat steps 2 and 3 a predetermined number of times, e.g., 25 times to achieve a test result that will have only a 5% chance of generating a false alarm (i.e., α=0.05).
5. Use the largest absolute differences found in the permuted data as the critical values (i.e., thresholds) in a two-stage hypothesis test.
6. Scan the actual demand history in the permuted data to find and record the largest absolute difference in Student's t-test for means (t-statistic) and the largest absolute difference in standard deviations that were encountered in the scan.
7. If the largest absolute t-statistic exceeds the largest absolute difference in means found in the permuted data, declare a regime change and report the location (i.e., point 40 in FIG. 4) of the regime change.
8. If there is no indication of change in the mean in step 7, do the same comparison for the absolute differences in standard deviations. If the standard deviation test is significant, i.e., exceeds the calculated limit, declare a regime change and report the location of the change. If not, declare no regime change.

As noted, once the revised time series data 18 (FIG. 1) is generated, it may be fed to a post processing system 20, where it is analyzed and processed to facilitate management of the technology platform 21 (or some other system 23). System 20 may for example include and utilize any type of predictive analytics, which uses historical data to predict future events. In various embodiments, historical data can be used to build a mathematical model that captures important trends. That predictive model is then used on revised time series data 18 to predict what will happen next, or to suggest actions to take for optimal outcomes.

For example, in a cloud computing system, the time series data could represent server demand and the analysis could be used to load balance remote user sessions to servers. In an autonomous vehicle, the time series data could represent sensor readings and the analysis could be fed into a machine learning model to control autonomous actions. In an ERP system, the time series data could represent demand of SKUs, and the analysis could be used to re-order SKU's. In business forecasting, a sequence of data values, e.g., daily sales of a product, are input to a statistical algorithm designed, first, to identify patterns such as trend and seasonality and characteristics such as volatility; then, second, to use that information to predict a range of likely future values of the time series.

By implementing the regime change detector 16 in any of these systems, the analysis will be improved and management of the technology platform 21 or other platform 23 will be enhanced. Management of the technology platform 21 may for example include automatically controlling the platform, providing analytics to platform operators, providing inputs to subsystems of the platform, outputting visualizations to a user interface, etc.

As described, regime change detector 16 is provided to detect a significant change in the character of a time series associated with resources in a technology platform 21. Such changes might involve the level (mean), spread (variance), correlation structure and/or distributional shape of the observations. Detecting such a change in a statistical regime permits identification and exclusion of obsolete and misleading observations from calculations on the time series, such as forecasts of future values. Conversely, non-detection of regime change justifies use of the full time series, allowing the greater accuracy and fidelity in calculated outputs that is possible when a larger number of stable data points are available for use.

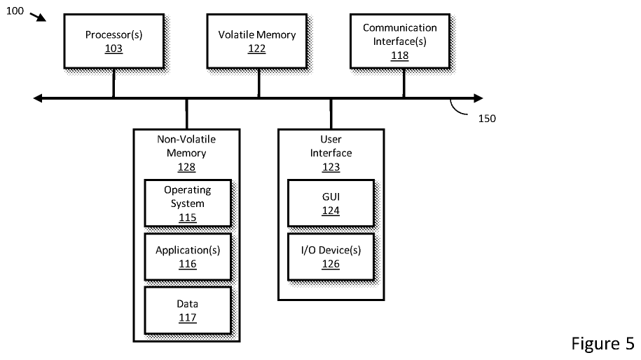

FIG. 5 depicts a block diagram of a computing device 100 useful for practicing an embodiment of time series data processing system 10. The computing device 100 includes one or more processors 103, volatile memory 122 (e.g., random access memory (RAM)), non-volatile memory 128, user interface (UI) 123, one or more communications interfaces 118, and a communications bus 150.

The non-volatile memory 128 may include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

The user interface 123 may include a graphical user interface (GUI) 124 (e.g., a touchscreen, a display, etc.) and one or more input/output (I/O) devices 126 (e.g., a mouse, a keyboard, a microphone, one or more speakers, one or more cameras, one or more biometric scanners, one or more environmental sensors, and one or more accelerometers, etc.). The non-volatile memory 128 stores an operating system 115, one or more applications 116, and data 117 such that, for example, computer instructions of the operating system 115 and/or the applications 116 are executed by processor(s) 103 out of the volatile memory 122. In some embodiments, the volatile memory 122 may include one or more types of RAM and/or a cache memory that may offer a faster response time than a main memory. Data may be entered using an input device of the GUI 124 or received from the I/O device(s) 126. Various elements of the computer 100 may communicate via the communications bus 150.

The illustrated computing device 100 is shown merely as an example client device or server and may be implemented by any computing or processing environment with any type of machine or set of machines that may have suitable hardware and/or software capable of operating as described herein.

The processor(s) 103 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some embodiments, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory.

In some embodiments, the processor 103 may be one or more physical processors, or one or more virtual (e.g., remotely located or cloud) processors. A processor including multiple processor cores and/or multiple processors may provide functionality for parallel, simultaneous execution of instructions or for parallel, simultaneous execution of one instruction on more than one piece of data.

The communications interfaces 118 may include one or more interfaces to enable the computing device 100 to access a computer network such as a Local Area Network (LAN), a Wide Area Network (WAN), a Personal Area Network (PAN), or the Internet through a variety of wired and/or wireless connections, including cellular connections.

In described embodiments, the computing device 100 may execute an application on behalf of a user of a client device. For example, the computing device 100 may execute on one or more virtual machines managed by a hypervisor. Each virtual machine may provide an execution session within which applications execute on behalf of a user or a client device, such as a hosted desktop session. The computing device 100 may also execute a terminal services session to provide a hosted desktop environment. The computing device 100 may provide access to a remote computing environment including one or more applications, one or more desktop applications, and one or more desktop sessions in which one or more applications may execute.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the disclosure. Accordingly, the foregoing description and drawings are by way of example only.

Various aspects of the present disclosure may be used alone, in combination, or in a variety of arrangements not specifically discussed in the embodiments described in the foregoing and is therefore not limited in this application to the details and arrangement of components set forth in the foregoing description or illustrated in the drawings. For example, aspects described in one embodiment may be combined in any manner with aspects described in other embodiments.

Also, the disclosed aspects may be embodied as a method, an example of which has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

1. A system, comprising:
a memory; and
a processor coupled to the memory and configured to process time series data for a set of resources according to a method that includes:
collecting time series data associated with resources in a technology platform;
analyzing each of a plurality of time series to determine whether a regime change occurred by evaluating distributions of values within the time series, and in response to a detected regime change in a time series, truncating the time series to generate a revised time series; and
utilizing the revised time series to facilitate management of the technology platform.

2. The system of claim 1, wherein determining whether the regime change occurred for a current time series includes:
for each point in the current time series:
dividing the current time series into a left and a right portion about the point; and
calculating a test statistic by comparing a distribution of values in the left and the right portions; and
identifying the point having a largest test statistic.

3. The system of claim 2, wherein determining the regime change further includes:
comparing the largest test statistic to a threshold;
in response to exceeding the threshold, confirming the point having the largest test statistic as the detected regime change; and
removing data before the detected regime change in the current time series.

4. The system of claim 2, wherein determining the regime change further includes:
determining a first test value that comprises an absolute difference between a Student's t-test for mean demand in the left and right portions of the current time series.

5. The system of claim 4, wherein determining the regime change further includes:
determining a second test value that comprises an absolute difference between a standard deviation in the left and right portions.

6. The system of claim 5, wherein determining the regime change includes:
permuting the current time series to generate a permuted time series;
for each point in the permuted time series, evaluating the permuted time series to find a largest first test value and a largest second test value;
repeating the permuting and evaluating steps a predetermined number of times to generate a dataset of the largest first test values and the largest second test values;
identifying the greatest of the largest first test values and largest second test values in the dataset as a first threshold and a second threshold, respectively;
for each point in the current time series, evaluating the current time series to find a current largest first test value and a current largest second test value;
in response to the current largest first test value exceeding the first threshold, recognizing a regime change; and
in response to the current largest first value exceeding the second threshold, recognizing a regime change.

7. The system of claim 2, wherein the test statistic is calculated using one of a chi-square test, a Kolmogorov-Smirnov test, and a Friedman-Rafsky test applied to a vector of series attributes.

8. The system of claim 1, wherein the resources are selected from a group consisting of: computing resources, energy resources, web resources, communication resources, physical or virtual components, autonomous vehicles, units of inventory, or Stock Keeping Unit (SKU) identifiers.

9. The system of claim 1, wherein the technology platform is selected from a group consisting of: a cloud computing system, a communication network, a computer network, a control system, a machine, an ERP system, or an inventory management service.

10. A method of processing time series data for a set of resources in a technology platform, the method comprising:
collecting time series data associated with resources in the technology platform;
analyzing each of a plurality of time series to determine whether a regime change occurred by evaluating distributions of values within the time series, and in response to a detected regime change in a time series, truncating the time series to generate a revised time series; and
utilizing the revised time series to predict future behavior of the resource in the technology platform.

11. The method of claim 10, wherein determining whether the regime change occurred for a current time series includes:
for each point in the current time series:
dividing the current time series into a left and a right portion about the point; and
calculating a test statistic by comparing a distribution of values in the left and the right portions; and
identifying the point having a largest test statistic.

12. The method of claim 11, wherein determining the regime change further includes:
comparing the largest test statistic to a threshold;
in response to exceeding the threshold, confirming the point having the largest test statistic as the detected regime change; and
removing data before the detected regime change in the current time series.

13. The method of claim 11, wherein determining the regime change further includes:
determining a first test value that comprises an absolute difference between a Student's t-test for mean demand in the left and right portions of the current time series.

14. The method of claim 13, wherein determining the regime change further includes:
determining a second test value that comprises an absolute difference between a standard deviation in the left and right portions.

15. The method of claim 14, wherein determining the regime change includes:
permuting the current time series to generate a permuted time series;
for each point in the permuted time series, evaluating the permuted time series to find a largest first test value and a largest second test value;
repeating the permuting and evaluating steps a predetermined number of times to generate a dataset of the largest first test values and the largest second test values;
identifying the greatest of the largest first test values and largest second test values in the dataset as a first threshold and a second threshold, respectively;
for each point in the current time series, evaluating the current time series to find a current largest first test value and a current largest second test value;
in response to the current largest first test value exceeding the first threshold, recognizing a regime change; and
in response to the current largest first value exceeding the second threshold, recognizing a regime change.

16. The method of claim 11, wherein the test statistic is calculated using one of a chi-square test, a Kolmogorov-Smirnov test, and a Friedman-Rafsky test applied to a vector of series attributes.

17. The method of claim 10, wherein the resources are selected from a group consisting of: computing resources, energy resources, web resources, communication resources, physical or virtual components, autonomous vehicles, units of inventory, or Stock Keeping Unit (SKU) identifiers.

18. The method of claim 10, wherein the technology platform is selected from a group consisting of: a cloud computing system, a communication network, a computer network, a control system, a machine, an ERP system, or an inventory management service.

19. A system, comprising:
a memory; and
a processor coupled to the memory and configured to process time series data for a set of resources according to a method that includes:
collecting time series data associated with resources in a technology platform;
analyzing each of a plurality of time series to determine whether a regime change occurred, and in response to a detected regime change in a time series, truncating the time series to generate a revised time series; and
inputting the revised time series into one of: a machine learning model or predictive model to control an aspect of the technology platform;
wherein determining whether the regime change occurred includes:
for each point in the current time series, dividing the current time series into a left and a right portion about the point and calculating a test statistic by comparing a distribution of values in the left and the right portions; and
identifying the point having a largest test statistic as a potential regime change.

20. The system of claim 19, further comprising:
recognizing a regime change in response to the largest test statistic being greater than a threshold.
